(19) United States
(12) Patent Application Publication
(10) Pub. No.: US 2017/0208447 A1
(43) Pub. Date: Jul. 20, 2017

(54) COMPUTING SYSTEM FOR COMMUNICATING THE PRESENCE OF A CLIENT DEVICE

(71) Applicant: Brilliant Service Innovations, LLC, Doral, FL (US)

(72) Inventors: Klaus Peters, Los Angeles, CA (US); Dilawer Hussain, Lahore Cantt (PK)

(21) Appl. No.: 15/154,742

(22) Filed: May 13, 2016

Related U.S. Application Data
(60) Provisional application No. 62/278,770, filed on Jan. 14, 2016.

(51) Int. Cl. H04W 8/00; G06Q 10/02; G06Q 20/32; H04W 4/00

(52) U.S. Cl. CPC H04W 8/005; H04W 4/008; G06Q 10/02; G06Q 20/322; H04W 8/20

(57) ABSTRACT

A computing system can include a sensor device that is positioned in close proximity to a host device and that is configured to broadcast its identifier using a short range wireless protocol. Client devices may also be configured to monitor for the identifier using the same short range wireless protocol. Accordingly, whenever a client device comes within proximity of the sensor device, the sensor device will receive the identifier. In response, the client device can be configured to transmit the identifier of the sensor device as well as an identifier of a user of the client device to a server. The server can employ the identifier of the sensor device to determine the location of the client device. The server can also employ the user's identifier to access a database to retrieve information of the user. The server can then provide this information to the host device.

### CROSS-REFERENCE TO RELATED APPLICATIONS

This application claims the benefit of U.S. Provisional Application No. 62/278,770 which was filed on Jan. 14, 2016.

### BRIEF SUMMARY

The present invention is generally directed to a computing system that is configured to detect and communicate the presence of a client device to a host device. The communication of the presence of the client device can include communicating an identifier of a user of the client device for the purpose of allowing the host device to retrieve and/or display information about the user.

In some embodiments, the computing system can include a sensor device that may be, but is not required to be, positioned in close proximity to the host device. The sensor device can be configured to broadcast its identifier using a short range wireless protocol (e.g., Bluetooth Low Energy). Client devices may also be configured to monitor for the identifier using the same short range wireless protocol. Accordingly, whenever a client device comes within proximity of the sensor device, the client device will receive the identifier. In response, the client device can be configured to transmit the identifier of the sensor device as well as an identifier of a user of the client device to a server. The server can employ the identifier of the sensor device to determine that the client device is located in close proximity to the sensor device. The server can also employ the user's identifier to access a database to retrieve information about the user. In some embodiments, this information can be specific to the location of the sensor device. The server can then provide this information to the host device.

As an example, the computing system of the present invention can be used in a restaurant, hotel, convention, or other location that receives frequent visitors as a means for individually identifying the visitors as well as for obtaining information about the visitors that can be employed to personalize services for the visitors. In such cases, the visitors can be offered a mobile application that can be installed on their smart phones or other mobile devices and that can be configured to monitor for identifiers broadcast by sensor devices and to communicate such identifiers along with user identifiers to the server.

In one embodiment, the present invention is implemented as a method for detecting the presence of a client device. A mobile application on a client device can detect a first sensor identifier that is being broadcast by a sensor device. In response to detecting the first sensor identifier, the mobile application can generate and send a communication to a server. The communication includes the first sensor identifier and an identifier of a first user of the client device. In response to receiving the communication, the server can employ the first sensor identifier to access a database defining mappings between sensor identifiers and locations including a mapping between the first sensor identifier and a first location. The server can also employ the identifier of the first user to access a database defining mappings between user identifiers and user information including a mapping between the identifier of the first user and the first user's information. In response to the access, the server can receive the first location and the first user's information and send at least a portion of the first user's information to one or more host devices that are located at the first location.

In another embodiment, the present invention is implemented as a computing system for detecting the presence of a client device that includes: a server; one or more host devices in communication with the server; a sensor device configured to broadcast a sensor identifier via a short range wireless protocol; and a client device configured to receive the sensor identifier when in close proximity to the sensor device, and in response, transmit the sensor identifier and a user identifier of a user of the client device to the server. The server employs the sensor identifier to determine a location of the client device and uses the user identifier to obtain information about the user. The server also transmits the information about the user to the one or more host devices to enable the host devices to display the information about the user thereby enabling a host at the location to customize a service based on the information about the user.

This summary is provided to introduce a selection of concepts in a simplified form that are further described below in the Detailed Description. This Summary is not intended to identify key features or essential features of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary computing environment in which the present invention can be implemented;

FIG. 2 illustrates an example where a number of host devices are configured to receive information about a number of users of client devices;

FIGS. 3A and 3B illustrate an example of a user interface that can be displayed on host devices to allow hosts to view detailed information about visitors;

FIG. 4 illustrates an example of how recommendations can be presented to a client device;

FIG. 5 illustrates an example of a user interface that displays recommendations; and

FIG. 6 illustrates a flowchart of an example method for detecting the presence of a client device.

### DETAILED DESCRIPTION

In this specification, a sensor device should be construed as a device that implements a short range wireless protocol. Currently, such sensor devices are oftentimes referred to as “beacons” and implement the Bluetooth Low Energy or “Bluetooth Smart” protocol (hereinafter generally “Bluetooth”). Accordingly, in preferred embodiments, a sensor device having a relatively small footprint is employed to allow the sensor device to be located in many different locations within an establishment. The specification will refer to Bluetooth as the protocol employed by the sensor device since this protocol is currently the standard for such communications. However, the present invention can equally be implemented with other short range wireless protocols including any protocol that may supplant Bluetooth as the standard.

A host device should be construed as any computing device, whether mobile or not, that is configured to communicate with a server for the purpose of receiving information about a user of a client device. For example, the host device can be a desktop computer, laptop computer, a tablet, a smart phone, a watch, a point-of-sale system, etc. A client device should be construed as any computing device that is mobile and that is configured to employ the same short range wireless protocol as a sensor device. In a typical scenario, a host device represents the computing device employed by an employee of an establishment that receives visitors, whereas a client device represents the computing device carried by the visitor. The terms “user” and “visitor” will be used synonymously to refer to the individual that carries a client device.

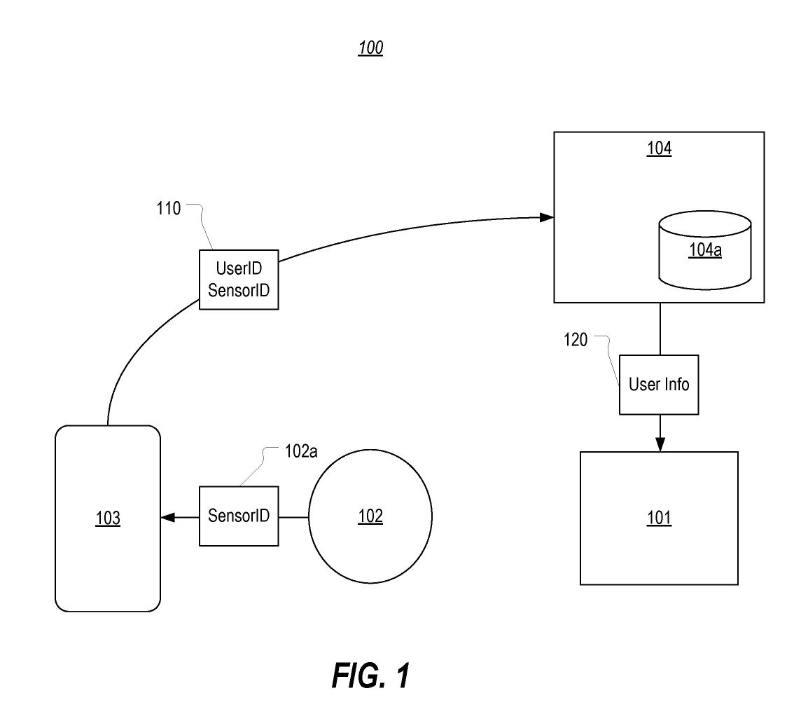

FIG. 1 illustrates an example of a computing environment 100 in which the present invention can be implemented. Computing environment 100 includes a host device 101, a sensor device 102, a client device 103, and a server 104. Sensor device 102 can be positioned in close proximity to host device 101. For example, in a retail establishment, host device 101 may be a point-of-sale terminal positioned on a counter and sensor device 102 may be positioned on or near the counter.

Sensor device 102 can be configured to continuously broadcast a sensor identifier 102a via Bluetooth. Client device 103 can be configured to monitor for broadcast sensor identifiers (e.g., using a mobile application installed on client device 103). Accordingly, when client device 103 comes within proximity of sensor device 102, client device 103 will detect sensor identifier 102a. Whenever client device 103 detects a sensor identifier, it can be configured to transfer the sensor identifier and an identifier of the user of client device 103 to server 104. For example, when client device 103 detects sensor identifier 102a, it can transmit a communication 110 that includes sensor identifier 102a and a user identifier to server 104. Communication 110 can typically be sent over an internet connection. In some embodiments, if client device 103 detects multiple sensor identifiers (i.e., when client device 103 is within range of multiple sensor devices), client device 103 can detect which sensor device is closest (e.g., based on signal strength) and include the sensor identifier of the closest sensor device in communication 110.

When server 104 receives communication 110, it can extract sensor identifier 102a and employ it to determine where client device 103 is located. To make this determination, database 104a may include mappings between sensor identifiers and locations. For example, if sensor device 102 is located in a fast food restaurant such as Chick-fil-A, database 104a may store a mapping between sensor identifier 102a and an identifier of the particular Chick-fil-A location. Such mappings can therefore allow server 104 to communicate information about the user to the host device(s) at the particular location that the user is visiting.

Server 104 can also be configured to employ the user identifier contained in communication 110 to obtain the appropriate user information from database 104a so that the user information can be provided to the host device(s). For example, this user information can include general information about the user (e.g., a name and picture of the user) as well as information about the user that is specific to the location (e.g., the user's purchase history or preferences at the location). Accordingly, FIG. 1 shows that server 104 sends a communication 120 containing user information to host device 101. In this way, an employee at the location can automatically obtain information about a visitor to the location thereby enabling the employee to customize services provided to the visitor.

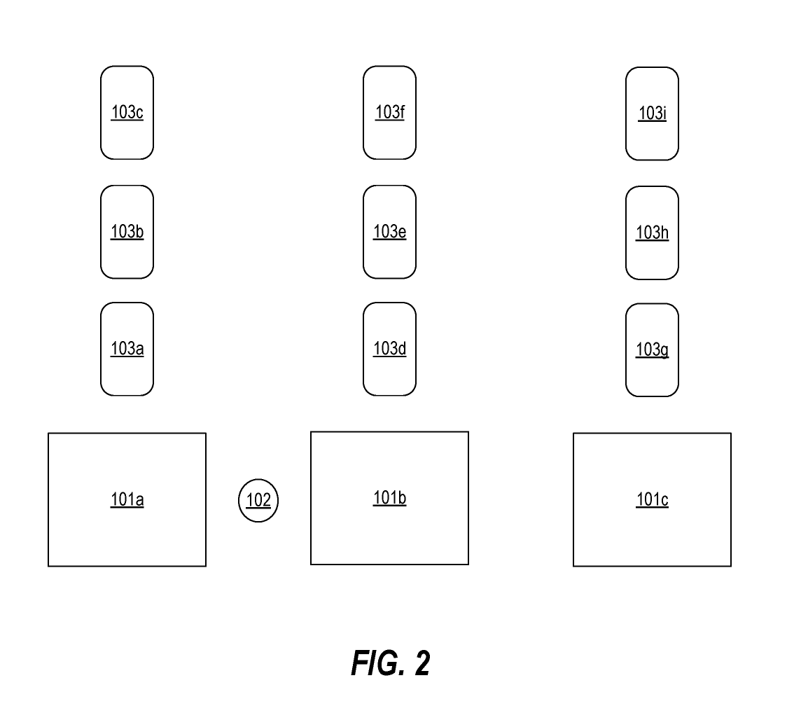

FIG. 2 provides a more detailed example of how the computing system of the present invention can be arranged. In this example, three host devices 101a-101c are depicted and can represent the different point-of-sale devices at an establishment such as a fast food restaurant or any other establishment that receives a number of visitors. Nine client devices 103a-103i are also shown. FIG. 2 can therefore represent a scenario where there are three lines of customers with each line having three customers, each of which is carrying a smart phone having an application configured to receive sensor identifier 102a and to communicate accordingly with server 104. It will be assumed that all nine of client devices 103a-103i are within the required proximity of sensor device 102 (i.e., they have received sensor identifier 102a) and therefore each of client devices 103a-103i has transmitted a communication 110 to server 104 containing sensor identifier 102a and the corresponding user identifier. It will further be assumed that server 104 has determined the location of each of client devices 103a-103i and obtained appropriate information about each of the nine visitors and transmitted this information to host devices 101a-101c. As a result, each of host devices 101a-101c can present information about each of the nine visitors.

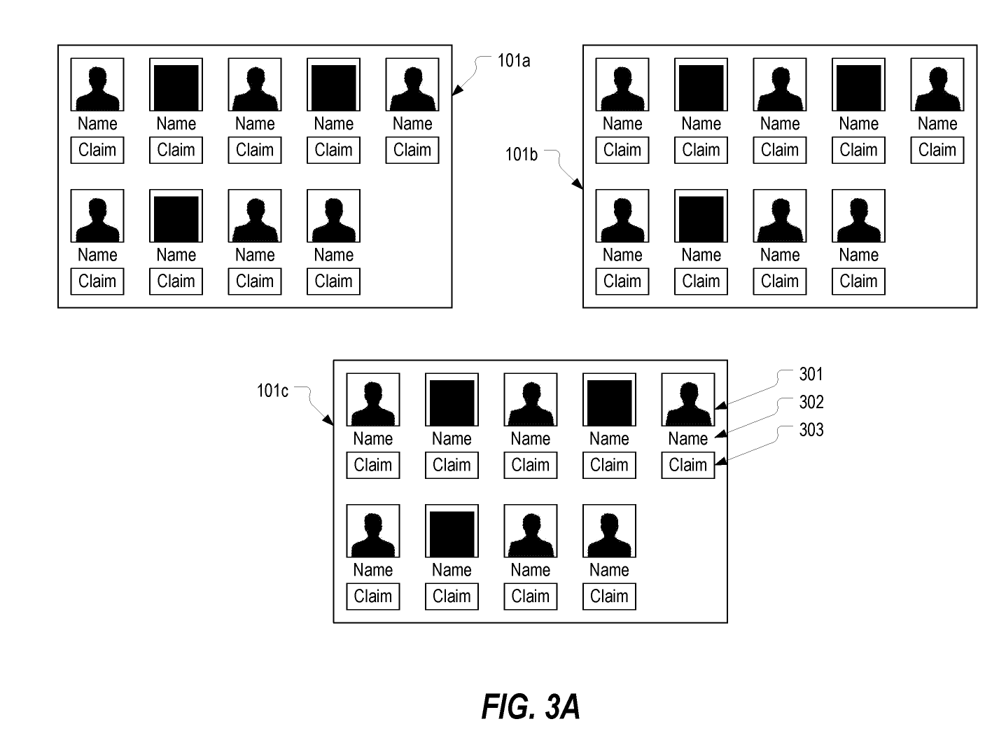

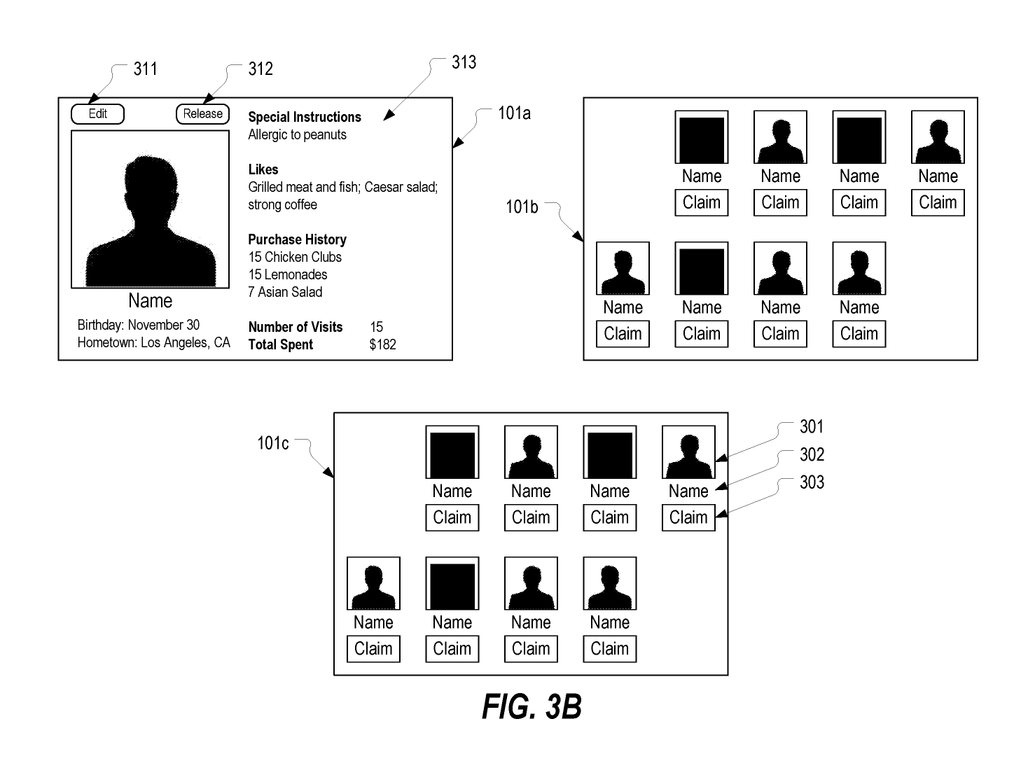

FIG. 3A depicts an example of the user interfaces that can be displayed on each of host devices 101a-101c when client devices 103a-103i are located in proximity to sensor device 102 as shown in FIG. 2. FIG. 3A can represent the state of the user interfaces prior to receiving any input from a host at the establishment. In this example, it will be assumed that there are three hosts—one for each of host devices 101a-101c. As shown, each of host devices 101a-101c displays representations 301 (e.g., pictures) of the users of client devices 103a-103i along with their names 302 and “claim” buttons 303. As explained above, the names and pictures of the users would have been provided to host devices 101a-101c by server 104 via communications 120.

Claim buttons 303 provide a means for a host to “claim” a user. In this context, claim refers to the action of a first host that selects a user to indicate to other hosts that the first host intends to serve the selected user. For example, if the establishment were a fast food restaurant, a host could select the claim button 303 for a particular user to indicate to all other hosts that the host will take the particular user's order.

FIG. 3B illustrates an example of how the user interfaces on host devices 101a-101c can be updated when a first host that is using host device 101a claims one of the users. In this example, it will be assumed that the first host has selected the user depicted in the top left corner of the user interfaces by tapping on the corresponding claim button and that this user is the user of client device 103a. As shown, in response to the first host selecting the user, the user interface on host device 101a is updated to display detailed information about the selected user. Also, the user interfaces on host devices 101b and 101c are updated to remove the user thereby preventing any other host from claiming the already claimed user. In some embodiments, the detailed information may have already been provided by server 104 to host devices 101a-101c. However, in other embodiments, the detailed information can be retrieved from server 104 in response to claim button 303 being selected.

Although not shown, in some embodiments, when a user is claimed, the host device that claimed the user can cause the claimed user's name to be audibly announced to the host. For example, host device 101a could audibly output the name or could cause a connected device (e.g., an earpiece) to output the name. Such audio could be provided as part of the general user information that server 104 provides to host devices 101a-101c.

When a user is claimed, the detailed information displayed about the user can include any type of information that may be useful to assist the host in serving the claimed user. For example, in FIG. 3B, the detailed information 313 includes the user's birthday (November 30), the user's hometown (Los Angeles), special instructions (that the user is allergic to peanuts), the user's likes (grilled meat and fish, Caesar salad, and strong coffee), the user's purchase history (15 Chicken club sandwiches, 15 lemonades, and 7 Asian salads), a number of times the user has visited that particular establishment (15), and the total amount the user has spent at the establishment (182). The detailed information 313 can be stored in database 104 and provided in the manner described above.

The detailed information 313 depicted in FIG. 3B is exemplary of a fast food restaurant. However, any type of detailed information may be stored and employed by a particular establishment. For example, a hotel may store the user's room preferences, number of nights stayed at the hotel, airline information, etc. To facilitate the storage of such information, the computing system of the present invention can be integrated with existing point-of-sale systems, reservation systems, or other similar systems employed by establishments. In this way, database 104 can be continuously updated as the users visit the establishment so that host devices can retrieve the most up-to-date information about the users. For example, as the host serves the user, the host can input information into host device 101a and such information can then be transmitted back to server 104 for storage in database 104a.

FIG. 3B also shows that the user interface on host device 101a includes an edit button 311 and a release button 312. Edit button 311 can be selected by the host to update detailed information 313. Any updates made via host device 101a could then be persisted to database 104 or back to client device 103a depending on the particular configuration of the computing system. Release button 312 can be selected by the host to “unclaim” the user, or, in other words, to cause the user to again be displayed on all host devices such as is depicted in FIG. 3A. For example, a host may claim a user, determine that the wrong user was claimed or that the user will be assisted by a different host, and then release the user.

Accordingly, the present invention allows hosts to easily obtain detailed information about visitors to an establishment so that the hosts can personalize service to these visitors. All that is required of a visitor to participate is that he or she install an application on his or her portable client device that is configured to monitor for sensor identifiers and to communicate appropriately with the server. By employing Bluetooth, the client device can automatically and continuously scan for any nearby sensor device, and once one is detected, transfer the sensor identifier and the user identifier to the server to initiate the process described above with reference to FIGS. 3A and 3B. For example, as a visitor walks into a fast food restaurant, the computing system of the present invention could automatically cause a picture and name of the visitor to be displayed on each of the restaurant's point-of-sale systems. The hosts of the fast food restaurant could then identify the visitor and greet him or her by name as well as customize the ordering process based on the visitor's detailed information.

In another example, a convention may employ the computing system of the present invention to be able to personally identify visitors to the convention. In such cases, a sensor device may be positioned near a check-in computing system to enable the functionality described above. In a further example, a hotel may employ the computing system to enhance the check-in process.

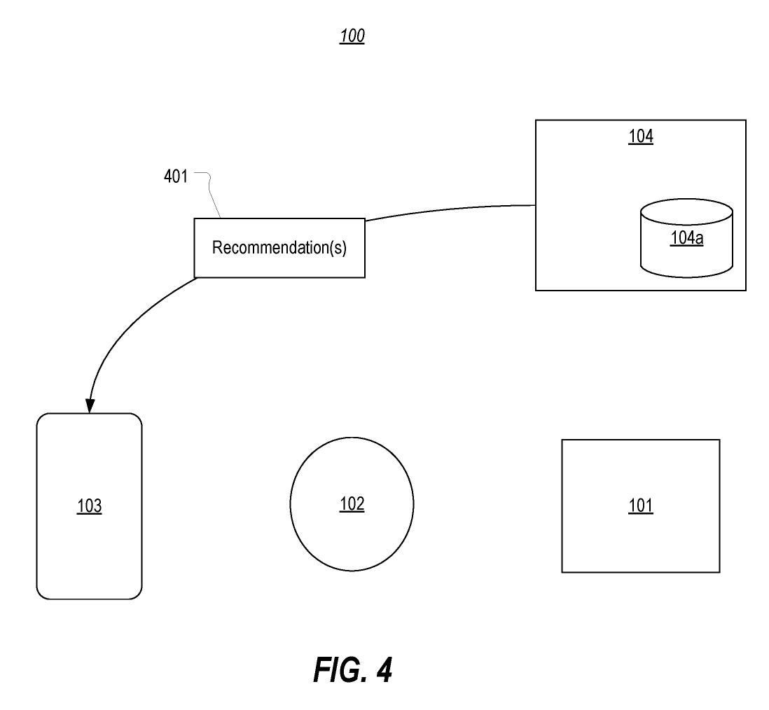

To this point, the computing system of the present invention has been described as allowing information about visitors to be displayed on host devices. Additionally, in some embodiments, the computing system of the present invention may be further configured to cause information to be displayed on the client devices. For example, server 104 could be configured to obtain recommendations (e.g., from database 104a) and relay them to the client devices. FIG. 4 illustrates an example of how this may be accomplished in a convention setting.

In FIG. 4, it is assumed that the process depicted in FIG. 1 has already been performed (i.e., server 104 already knows where the user of client device 103 is located). Based on the user's determined location and possibly other information about the user, server 104 can determine recommendations for the user. For example, these recommendations can be based on the user's preferences, a hotel where the user is staying, activities that the user may have scheduled, etc. As mentioned, such information may be stored in database 104a or may otherwise be accessible to server 104. Then, after determining appropriate recommendations for the user, server 104 can transmit a communication 401 containing such recommendations to client device 103. Client device 103 can then display these recommendations to the user (e.g., via a mobile application).

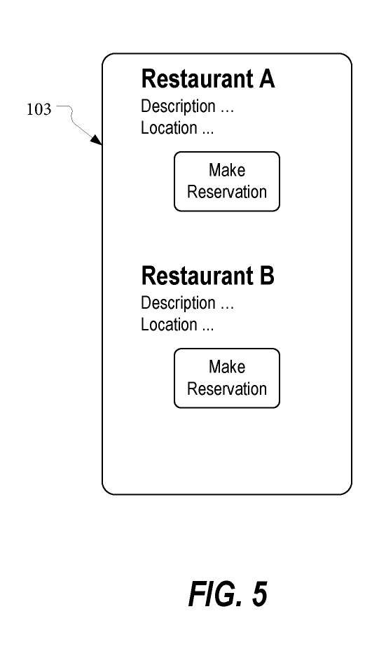

In some embodiments, the recommendations may include an option for making a reservation. FIG. 5 provides an example of how this may be done. As shown, recommendations for two restaurants are displayed, and each recommendation includes a “make reservation” button that the user can select to make a reservation with the restaurant. In some embodiments, the computing system can be configured to track how many users make reservations in the manner described above. The computing system can also be configured to allow the users to provide feedback on visited restaurants or other establishments. Such information can be provided to the convention bureau for tracking purposes.

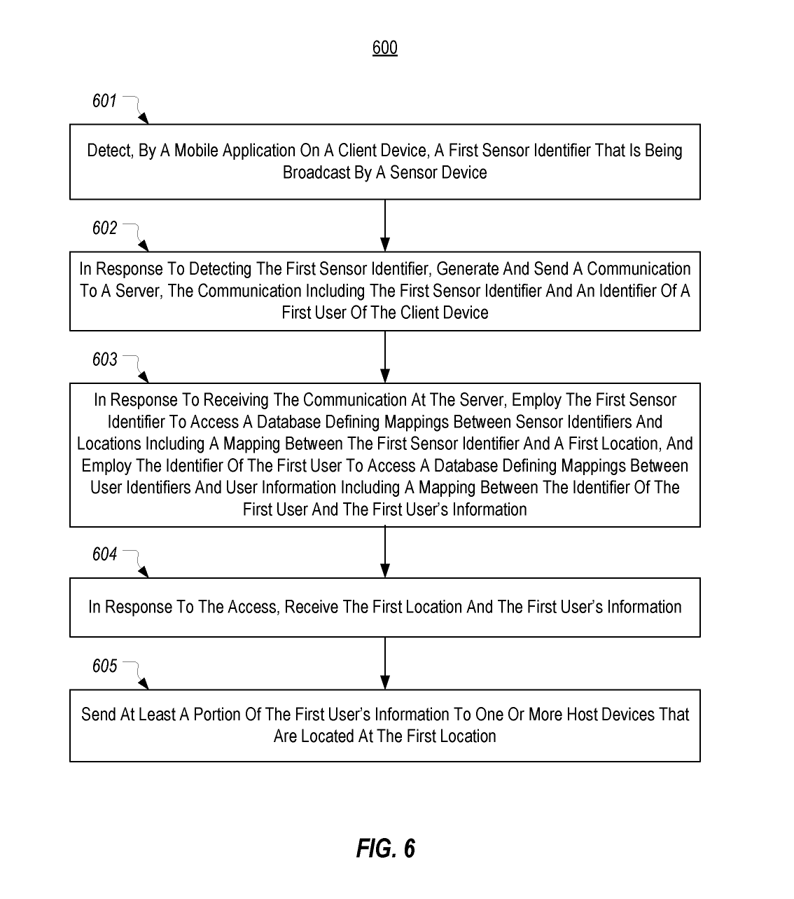

FIG. 6 illustrates a flowchart of an example method 600 for detecting the presence of a client device. Method 600 will be described with reference to the example computing environment depicted in FIG. 1.

Method 600 includes an act 601 of detecting, by a mobile application on a client device, a first sensor identifier that is being broadcast by a sensor device. For example, a mobile application on client device 103 can detect sensor identifier 102a that is broadcast by sensor device 102. If the mobile application on client device 103 detects multiple sensor identifiers, it may also detect which sensor identifier corresponds to the closest sensor device.

Method 600 includes an act 602 of, in response to detecting the first sensor identifier, generating and sending a communication to a server, the communication including the first sensor identifier and an identifier of a first user of the client device. For example, the mobile application on client device 103 can send communication 110 to server 104.

Method 600 includes an act 603 of, in response to receiving the communication at the server, employing the first sensor identifier to access a database defining mappings between sensor identifiers and locations including a mapping between the first sensor identifier and a first location, and employing the identifier of the first user to access a database defining mappings between user identifiers and user information including a mapping between the identifier of the first user and the first user's information. For example, server 104 can access database 104a to identify the location of client device 103 and to obtain information about the user of client device 103.

Method 600 includes an act 604 of, in response to the access, receiving the first location and the first user's information. For example, server 104 can receive the location associated with the sensor identifier included in communication 110 and user information associated with the user identifier included in communication 110.

Method 600 includes an act 605 of sending at least a portion of the first user's information to one or more host devices that are located at the first location. For example, server 104 may obtain a portion of the user's information that pertains to the location of host device 101 and then send the user's information to host device 101.

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including personal computers, desktop computers, laptop computers, message processors, hand-held devices, multi-processor systems, microprocessor-based or programmable consumer electronics, network PCs, mobile telephones, PDAs, tablets, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A method for detecting the presence of a client device comprising:
detecting, by a mobile application on a client device, a first sensor identifier that is being broadcast by a sensor device;
in response to detecting the first sensor identifier, generating and sending a communication to a server, the communication including the first sensor identifier and an identifier of a first user of the client device;
in response to receiving the communication at the server, employing the first sensor identifier to access a database defining mappings between sensor identifiers and locations including a mapping between the first sensor identifier and a first location, and employing the identifier of the first user to access a database defining mappings between user identifiers and user information including a mapping between the identifier of the first user and the first user's information;
in response to the access, receiving the first location and the first user's information; and
sending at least a portion of the first user's information to one or more host devices that are located at the first location.

2. The method of claim 1, wherein detecting the first sensor identifier comprises receiving the first sensor identifier via a short range wireless protocol.

3. The method of claim 1, wherein the mapping between the first sensor identifier and the first location identifies the one or more host devices.

4. The method of claim 1, wherein the at least a portion of the first user's information comprises a portion of the first user's information that pertains to the first location.

5. The method of claim 1, wherein the portion of the first user's information that pertains to the first location comprises information obtained by the one or more host devices when the first user had previously visited to the first location.

6. The method of claim 1, further comprising:
displaying, on at least one of the one or more host devices, a representation of the first user in conjunction with a first user interface element; and
in response to a selection of the first user interface element displayed on a first host device of the one or more host devices, displaying the first user's information on the first host device.

7. The method of claim 6, wherein the one or more host devices comprise a plurality of host devices and the representation and first user interface element are displayed on the plurality of host devices, the method further comprising:
in response to the selection of the first user interface element on the first host device, ceasing the display of one or both of the representation of the first user or the first user interface element on the other host devices.

8. The method of claim 7, wherein displaying the first user's information on the first host device includes displaying a second user interface element, the method further comprising:
in response to a selection of the second user interface element, ceasing the display of the first user's information on the first host device and instead displaying the representation of the first user and the first user interface element on the first host device; and
resuming the display of one or both of the representation of the first user or the first user interface element on the other host devices.

9. The method of claim 6, further comprising:
receiving input at the first host device defining a purchase or request of the first user; and
sending the input to the server for inclusion in the first user's information.

10. The method of claim 1, further comprising:
identifying, by the server, one or more recommendations based on one or both of the first location or the first user's information; and
sending the one or more recommendations to the client device.

11. The method of claim 10, wherein the one or more recommendations represent one or more other locations and include an option for making a reservation at the one or more other locations.

12. A computing system for detecting the presence of a client device comprising:
a server;
one or more host devices in communication with the server;
a sensor device configured to broadcast a sensor identifier via a short range wireless protocol; and
a client device configured to receive the sensor identifier when in close proximity to the sensor device, and in response, transmit the sensor identifier and a user identifier of a user of the client device to the server;
wherein the server employs the sensor identifier to determine a location of the client device and uses the user identifier to obtain information about the user, and wherein the server transmits the information about the user to the one or more host devices to enable the host devices to display the information about the user thereby enabling a host at the location to customize a service based on the information about the user.

13. The computing system of claim 12, wherein the host device is configured to display the information about the user in conjunction with a user interface element that allows a host to claim the user.

14. The computing system of claim 12, wherein the information about the user includes information that is particular to the location.

15. The computing system of claim 12, wherein the server is configured to employ one or both of the location or the information about the user to identify and send one or more recommendations to the client device or display to the user.

16. The computing system of claim 15, wherein the one or more recommendations represent one or more other locations and include an option for making a reservation at the one or more other locations.

17. One or more computer storage media storing computer executable instructions which when executed implement a method for detecting the presence of a client device, the method comprising:
detecting, by a mobile application on a client device, a first sensor identifier that is being broadcast by a sensor device;
in response to detecting the first sensor identifier, generating and sending a communication to a server, the communication including the first sensor identifier and an identifier of a first user of the client device;
in response to receiving the communication at the server, employing the first sensor identifier to access a database defining mappings between sensor identifiers and locations including a mapping between the first sensor identifier and a first location, and employing the identifier of the first user to access a database defining mappings between user identifiers and user information including a mapping between the identifier of the first user and the first user's information;
in response to the access, receiving the first location and the first user's information; and
sending at least a portion of the first user's information to one or more host devices that are located at the first location.

18. The computer storage media of claim 17, wherein the method further comprises:
displaying, on at least one of the one or more host devices, a representation of the first user in conjunction with a first user interface element; and
in response to a selection of the first user interface element displayed on a first host device of the one or more host devices, displaying the first user's information on the first host device.

19. The computer storage media of claim 18, wherein the one or more host devices comprise a plurality of host devices and the representation and first user interface element are displayed on the plurality of host devices, the method further comprising:
in response to the selection of the first user interface element on the first host device, ceasing the display of one or both of the representation of the first user or the first user interface element on the other host devices.

20. The computer storage media of claim 19, wherein displaying the first user's information on the first host device includes displaying a second user interface element, the method further comprising:
in response to a selection of the second user interface element, ceasing the display of the first user's information on the first host device and instead displaying the representation of the first user and the first user interface element on the first host device; and
resuming the display of one or both of the representation of the first user or the first user interface element on the other host devices.
